(19) United States
(12) Patent Application Publication
(10) Pub. No.: US 2025/0074034 A1
(43) Pub. Date: Mar. 6, 2025

(54) LAMINATE PREFORM AND METHOD OF FORMING A LAMINATE USING SAME

(71) Applicant: CORNING INCORPORATED, CORNING, NY (US)

(72) Inventors: Benjamin Patrick Butler, Elmira, NY (US); Thomas Michael Cleary, Elmira, NY (US); William Keith Fisher, Corning, NY (US); Evan Gray Kister, Painted Post, NY (US)

(21) Appl. No.: 18/811,145

(22) Filed: Aug. 21, 2024

Related U.S. Application Data
(60) Provisional application No. 63/534,889, filed on Aug. 28, 2023.

(51) Int. Cl. B32B 17/00; B32B 27/36; B32B 37/12; B32B 37/26

(52) U.S. Cl. CPC B32B 17/00; B32B 27/36; B32B 37/1207; B32B 37/1284; B32B 2037/268; B32B 2250/03; B32B 2307/416; B32B 2307/7376; B32B 2605/08

(57) ABSTRACT

Disclosed herein are embodiments of a laminate preform. The laminate preform includes a first glass ply having a first major surface and a second major surface. The second major surface is opposite to the first major surface. A thickness of the first glass ply is defined between the first major surface and the second major surface. The thickness is 2 mm or less. The laminate preform also includes an adhesive region having a third major surface and a fourth major surface. The third major surface is disposed on the second major surface of the first glass ply. The third major surface of the adhesive region includes at least a portion of area not bonded to the second major surface so that air can flow between the third major surface and the second major surface.

### CROSS-REFERENCE TO RELATED APPLICATIONS

This application claims the benefit of priority of U.S. Application Ser. No. 63/534,889, filed on Aug. 28, 2023, the content of which is relied upon and incorporated herein by reference in its entirety.

### BACKGROUND

The disclosure relates to glass laminate structures, and more particularly to a laminate preform for forming a laminate structure.

Glass is used in windows because of its optical clarity and durability. Automotive and architectural windows may include a single glass ply or a laminate that includes two glass plies with an adhesive layer of a polymeric material disposed in between. For automotive applications in particular, there is a trend toward using laminates for improved fuel economy and/or impact performance.

### SUMMARY

According to a first aspect, embodiments of the present disclosure relate to a laminate preform. The laminate preform includes a first glass ply having a first major surface and a second major surface. The second major surface is opposite to the first major surface. A thickness of the first glass ply is defined between the first major surface and the second major surface. The thickness is 2 mm or less. The laminate preform also includes an adhesive region having a third major surface and a fourth major surface. The third major surface is disposed on the second major surface of the first glass ply. The third major surface of the adhesive region includes at least a portion of area not bonded to the second major surface so that air can flow between the third major surface and the second major surface.

According to a second aspect, embodiments of the present disclosure relate to a method of preparing a laminate preform. In the method, an adhesive region is attached to a first glass ply. The first glass ply includes a first major surface and a second major surface, and the second major surface is opposite to the first major surface. The adhesive region includes a third major surface and a fourth major surface in which the third major surface is disposed on the second major surface. The third major surface is attached to the second major surface, and the third major surface includes at least a portion of area not bonded to the second major surface so that air can flow between the third major surface and the second major surface.

According to a third aspect, embodiments of the present disclosure relate to a method of preparing a laminate using a laminate preform according to the first aspect. In the method, the laminate preform is cold-formed against a second glass ply having a curvature. The second glass ply has a fifth major surface and a sixth major surface. The sixth major surface is opposite to the fifth major surface, and the fifth major surface and the sixth major surface define a second thickness therebetween. The second thickness is greater than the thickness of the first glass ply. The fourth major surface of the adhesive region is attached to the fifth major surface of the second glass ply. The first glass ply conforms to the curvature of the second glass ply.

According to a fourth aspect, embodiments of the present disclosure relate to an apparatus for forming a laminate structure. The apparatus includes a first mold configured to receive a curved glass ply and a second mold configured to cold-form a laminate preform against the curved glass ply. The laminate preform includes a flat glass ply and an adhesive region attached thereto. At least one of the first mold and the second mold includes a plurality of local heating elements configured to heat the adhesive region through the respective curved glass ply or flat glass ply to facilitate bonding of the adhesive region to the curved glass ply and to the flat glass ply.

According to a fifth aspect, embodiments of the present disclosure relate to a method of forming a laminate using the apparatus according to the fourth aspect. In the method, the curved glass ply is positioned in the first mold. The laminate preform is positioned in the first mold over the curved glass ply. The second mold is pressed onto the laminate preform to cold-form the laminate preform against the curved glass ply, and the adhesive region is heated using the plurality of local heating elements to attach the laminate preform to the curved glass ply.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 is an illustration of a vehicle including a glazing in the form of a laminate, according to one or more exemplary embodiments;

FIG. 2 is a laminate including two glass plies joined by an adhesive region, according to one or more exemplary embodiments;

FIGS. 3A and 3B depict cold-forming of a laminate from a laminate preform, according to one or more exemplary embodiments;

FIG. 4 depicts a laminate preform including a release layer covering one surface of the adhesive region, according to one or more exemplary embodiments;

FIGS. 5A and 5B depict a laminate preform including a functional layer (FIG. 5A) and a laminate formed from same (FIG. 5B), according to one or more exemplary embodiments;

FIG. 6 depicts a laminate preform including regions of the adhesive region bonded to the glass ply and regions of the adhesive reguib that are not bonded to the glass ply, according to exemplary embodiments;

FIGS. 7A and 7B depict a clip configured to mechanically hold the adhesive region and glass ply together and position them relative to another glass ply of a laminate, according to one or more exemplary embodiments; and

FIGS. 8A-8C depict an apparatus and method for forming a laminate, according to one or more exemplary embodiments.

### DETAILED DESCRIPTION

Reference will now be made in detail to various embodiments of a laminate preform configured to facilitate the assembly of laminate structures, examples of which are illustrated in the accompanying drawings. Embodiments of the disclosure relate to a laminate preform including at least a glass ply and an adhesive region that is attached to the glass ply. As will be described more fully below, the adhesive region is not fully bonded to the glass ply as it would be in the final laminate. Instead, the adhesive region is tacked or mechanically attached to the glass ply to provide proper alignment between the glass ply and the adhesive region. In this way, during a lamination process involving the cold-forming of the glass ply against a curvature of another glass ply, concerns regarding misalignment of the adhesive region and glass ply relative to the curved glass ply are reduced. Additionally, the laminate preform can include other functional layers, additives within the adhesive region, or coatings on the glass ply that can be more easily assembled or applied in a flat configuration and cold-formed together with the laminate preform. These and other aspects and advantages of the disclosed laminate preform will be described more fully below. The embodiments discussed herein are presented by way of illustration and not limitation.

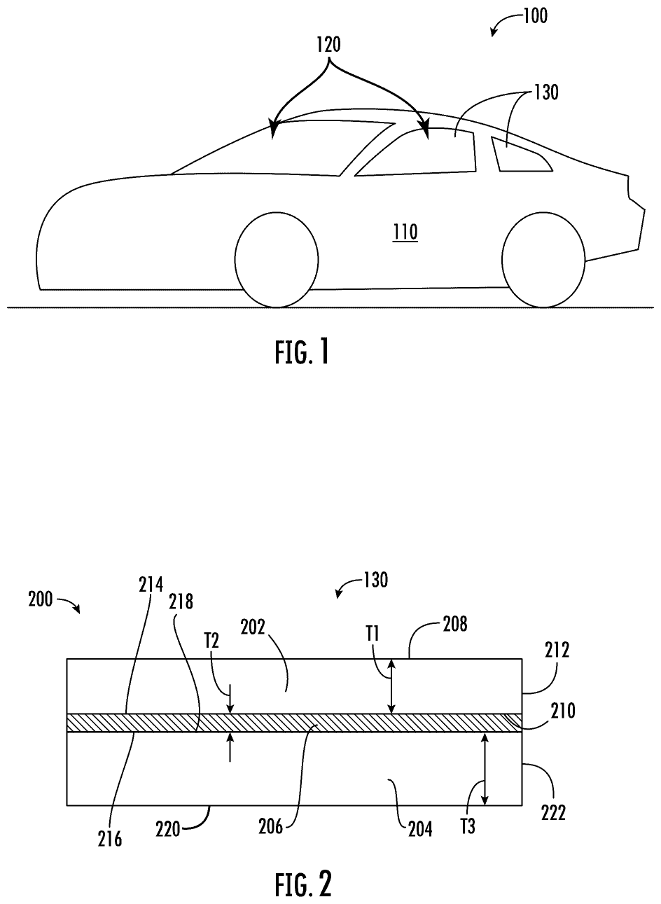

FIG. 1 depicts an example embodiment of a vehicle 100. The vehicle 100 includes a body 110 defining an interior and at least one opening 120 in communication with the interior. The vehicle 100 further includes an automotive glazing 130, i.e., window, disposed in the opening 120. The automotive glazing 130 may form at least one of the sidelights, windshield, rear window, windows, and sunroof in the vehicle 100. In some embodiments, the automotive glazing 130 may form an interior partition (not shown) within the interior of the vehicle 100, or may be disposed on an exterior surface of the vehicle 100 and form, e.g., an engine block cover, headlight cover, taillight cover, door panel cover, or pillar cover. As used herein, the term “vehicle” includes automobiles (an example of which is shown in FIG. 1), rolling stock, locomotives, boats, ships, airplanes, helicopters, drones, space craft, and the like. Further, while the present disclosure is framed in terms of a vehicle, the disclosure may relate to other contexts, such as architectural glazing or bullet-resistant glazing applications.

As shown in FIG. 2, in embodiments, the automotive glazing 130 is a laminate 200 comprised of a first glass ply 202, a second glass ply 204, and an adhesive region 206 disposed between the first glass ply 202 and the second glass ply 204. In the embodiment depicted in FIG. 1, the laminate 200 includes an adhesive region 206 with a single adhesive layer that bonds the first glass ply 202 to the second glass ply 204.

The first glass ply 202 includes a first major surface 208 and a second major surface 210. The second major surface 210 is opposite to the first major surface 208. A first minor surface 212 extends between the first major surface 208 and the second major surface 210 and around a periphery of the first glass ply 202. Further, the first major surface 208 and the second major surface 210 define a first thickness T1 of the first glass ply 202. In one or more embodiments, the first thickness T1 of the first glass ply 202 is 2 mm or less, in particular in a range from 0.2 mm to 2 mm, and more particularly in a range from 0.4 mm to 1.1 mm. In one or more embodiments, the first glass ply 202 is formed from an alkali aluminosilicate glass, soda lime glass, or borosilicate glass, among other possibilities. In one or more embodiments, the first glass ply 202 is chemically strengthened, such as through an ion-exchange process. In one or more embodiments, the first major surface 208 faces the interior of the vehicle.

The adhesive region 206 has a third major surface 214 and a fourth major surface 216. The fourth major surface 216 is opposite to the third major surface 214. The third major surface 214 and the fourth major surface 216 define a second thickness T2 of the adhesive region 206. In one or more embodiments, the second thickness T2 of the adhesive region 206 is 2 mm or less, in particular in a range from 0.38 mm to 1.52 mm, and more particularly in a range from 0.38 mm to 0.84 mm.

In one or more embodiments, the adhesive region 206 comprises a polyvinyl butyral (PVB), an acoustic PVB (APVB), an ethylene-vinyl acetate (EVA), a thermoplastic polyurethane (TPU), an ionomer, a polyester (PES), or a polyethylene terephthalate (PET). In one or more embodiments, the adhesivion region 206 includes at least one functional additive, such as solar-absorbing pigment, tinting colorant, UV absorbing compounds, light scattering particles, or adhesion promoters, among other possibilities.

Further, as will be discussed more fully below, the adhesive region 206 may encapsulate a functional layer. In such embodiments, functional layer may be encapsulated by two adhesive layers. Each adhesive layer of the adhesive region 206 may have a thickness in a range from 0.38 mm to 0.84 mm.

In embodiments, the third major surface 214 and the fourth major surface 216 of the adhesive region 206 have a surface roughness that facilitates removal of air from between the adhesive region 206 and the respective glass plies 202, 204 during lamination. In one or more embodiments, the surface roughness is characterized by at least one of three parameters, Rz, Rv, and RSm. Rz is the absolute vertical distance between a maximum profile height and a maximum profile depth along a measurement length. Rv is a maximum profile depth along a measurement length, and RSm is the average length of the profile features. In one or more embodiments, Rv is in a range from 9 μm to 35 μm. In one or more embodiments, Rz is in a range from 15 μm to 55 μm. In one or more embodiments, RSm is in a range from 100 μm to 800 μm. In one or more embodiments, the surface roughness measurements referenced herein are measured in accordance with ISO 4287. In embodiments, regions of the third major surface 214 that are not initially tacked to the first glass ply 202 have Rv, Rz, and RSm values lying in the foregoing ranges to facilitate air removal during the process of lamination with the second glass ply. The initial tacking of the adhesive region 206 described herein to the first glass ply 202 aids in maintain the surface roughness of the adhesive region 206 to allow for subsequent lamination.

The second glass ply 204 includes a fifth major surface 218 and a sixth major surface 220. The sixth major surface 220 is opposite to the fifth major surface 218. A second minor surface 222 extends between the fifth major surface 218 and the sixth major surface 220 and around a periphery of the second glass ply 204. Further, the fifth major surface 218 and the sixth major surface 220 define a third thickness T3 of the second glass ply 204 therebetween. In one or more embodiments, the third thickness T3 of the second glass ply 204 is greater than the first thickness T1 of the first glass ply 202. In one or more embodiments, the third thickness T3 of the second glass ply 204 is at least 2 mm, in particular in a range from 2 mm to 5 mm, and more particularly in a range from 2.5 mm to 3.5 mm. In one or more embodiments, the second glass ply 204 is formed from soda lime glass, aluminosilicate glass, fusion formed borosilicate glass, borosilicate float glass, or phosphate glass, among other possibilities. In one or more embodiments, the second glass ply 204 is annealed, fully or partially thermally tempered, or ion-exchange strengthened. In one or more embodiments, the sixth major surface 220 may define, in part, the exterior of the vehicle.

In one or more embodiments, the first glass ply 202 or second glass ply 204 may be provided with a functional or decorative coating in addition to or in the alternative to the functional or decorative element of the adhesive region 206. In embodiments, the coating is at least one of an infrared reflective (IRR) coating, frit, enamel, anti-reflective coating, or pigment coating. In an example embodiment of an IRR, the second major surface 210 of the first glass ply 202 or the fifth major surface 218 of the second glass ply 204 is coated with an infrared-reflective film and, optionally, one or more layers of a transparent dielectric film. In embodiments, the infrared-reflecting film comprises a conductive metal, such as silver, gold, or copper, that reduces the transmission of heat through the coated ply 202, 204. In embodiments, the optional dielectric film can be used to anti-reflect the infrared-reflecting film and to control other properties and characteristics of the coating, such as color and durability. In embodiments, the dielectric film comprises one or more oxides of zinc, tin, indium, bismuth, and titanium, among others. In an example embodiment, the IRR coating includes one or two silver layers each sandwiched between two layers of a transparent dielectric film. In embodiments, the IRR coating is applied using, e.g., physical or chemical vapor deposition or via lamination.

In embodiments, the coating is an anti-reflective coating. In particular embodiments, the anti-reflective coating is applied to the first major surface 208 of the first glass ply 202. In embodiments, the anti-reflective coating comprises multiple layers of low and high index materials or low, medium, and high index materials. For example, in embodiments, the anti-reflective coating includes from two to twelve layers of alternating low and high index materials, such as silica (low index) and niobia (high index). In another example embodiment, the anti-reflective coating includes from three to twelve layers of repeating low, medium, and high index materials, such as silica (low index), alumina (medium index), and niboia (high index). In still other embodiments, the low index material in the stack may be an ultra low index material, such as magnesium fluoride or porous silica. In general, anti-reflective coatings having more layers in the stack will perform better at higher angles of incidence than anti-reflective coatings having less layers in the stack. For example, at an angle of incidence of, e.g., greater than 60°, an anti-reflective coating stack having four layers will perform better (less reflection) than an anti-reflective coating stack having two layers. Further, in embodiments, an anti-reflective coating stack having an ultra low index material will perform better (less reflection) than an anti-reflective coating stack having a low index material. Other anti-reflective coatings known in the art may also be suitable for application to the laminate 200.

In the embodiment shown in FIG. 2, the laminate 200 consists of the first glass ply 202, the second glass ply 204, and an adhesive region 206 including a single adhesive layer. In the formed laminate 200, the third major surface 214 of the adhesive region 206 is bonded to the second major surface 210 of the first glass ply 202, and the fourth major surface 216 of the adhesive region 206 is bonded to the fifth major surface 218 of the second glass ply 204. In particular, during assembly of the laminate 200, sufficient heat and pressure is applied to the stack of first glass ply 202, adhesive region 206, and second glass ply 204 to drive out substantially all of the air between the layers of the first glass ply 202, adhesive region 206, and second glass ply 204. The surface roughness of the adhesive region 206 described above facilitates the removal of air between the layers by providing a leak path for evacuation of the air. In general, this surface roughness is disrupted during the lamination process.

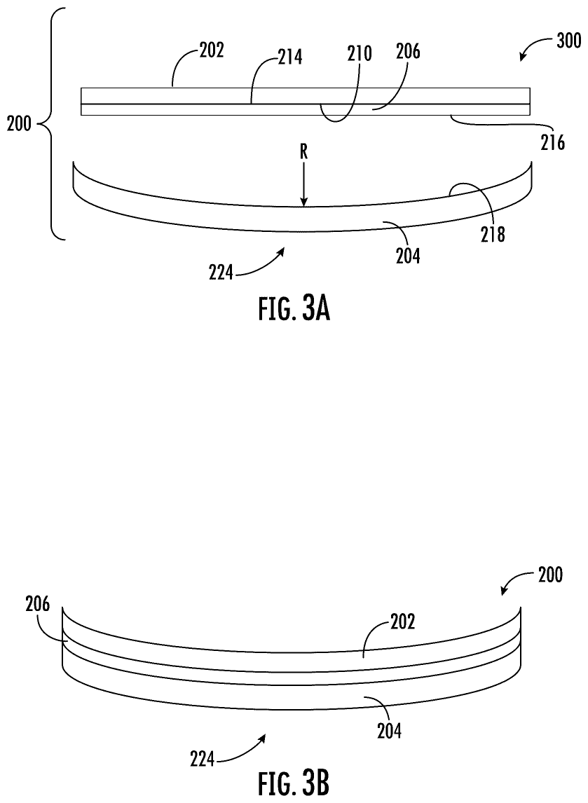

However, the temperature during assembly of the stack is kept below the softening point of the glass plies 202, 204 such that the process is still considered a cold-forming process. In particular, the temperature during assembly of the laminate 200 is kept at 200° C. or less, 175° C. or less, or 150° C. or less, 125° C. or less, or 100° C. or less. More particularly, as shown in FIG. 3A, the second glass ply 204 may include a curvature 224 having a radius of curvature R in a range from 1000 mm to 5000 mm, in particular from 1500 mm to 2300 mm, and as shown in FIG. 3B, the first glass ply 202 is pressed against the second glass ply 204 so that the first glass ply 202 conforms to the curvature 224 of the second glass ply 204.

According to embodiments of the present disclosure and as shown in FIG. 3A, assembly of the laminate 200 is facilitated by use of a laminate preform 300 in which the adhesive region 206 is initially attached to the first glass ply 202 prior to lamination with the second glass ply 204. As will be discussed more fully below, certain existing laminate structures are assembled with the glass plies and the adhesive region being separate structures that are brought together in a single lamination step. That is, any bonding between the adhesive region 206 and the first and second glass plies 202 and 204 occurs during a single lamination process. However, Applicant has found that maintaining alignment of the adhesive region and the glass plies can be difficult, especially when one of the glass plies is cold-formed. By providing the first glass ply 202 and adhesive region 206 together in a laminate preform 300, where the adhesive region 206 is pre-joined to the first glass ply 206 in a desired alignment therewith, the alignment of the first glass ply 202 and the adhesive region 206 with each other and with the second glass ply 204 is more accurately and more easily maintained.

According to certain embodiments, the lamination process may involve a first heating step at a first temperature during which the laminate preform 300 is tacked to the second glass ply 204 to cold-form the laminate preform 300 and de-aired by applying vacuum or suction to the preform 300 and second glass ply 204. In a second heating step at a second temperature and pressure, the adhesive region 206 is fully bonded to the plies 202, 204. In one or more embodiments, the second heating step is performed such that the second temperature is greater than the first temperature. In one or more embodiments, the second heating step may be performed in an autoclave, e.g., at a temperature of 110° C. to 150° C. and at a pressure of 150 psi to 200 psi.

In the laminate preform 300, the third major surface 214 of the adhesive region 206 is attached to the second major surface 210 of the first glass ply 202. However, the attachment between the third major surface 214 of the adhesive region 206 and the second major surface 210 of the first glass ply 202 is not a final, full bond of the third major surface 214 across the second major surface 210. That is, the attachment of the adhesive region 206 and the first glass ply 202 in the laminate preform 300 is not at the level of the final bonding provided between the adhesive region 206 and the first glass ply 202 in the laminate 200 in which sufficient heat and pressure are applied to drive out air from between the adhesive region 206 and the first glass ply 202 to provide full bonding across the third major surface 214 and second major surface 210. Instead, as will be discussed more fully below, the adhesive region 206 of the preform 300 is, for example, tacked, partially bonded, or mechancically coupled to the first glass ply 202. In particular, at least a portion of the area of the third major surface 214 are not bonded to the second major surface 210 so that air can flow between the third major surface 214 and the second major surface 210. As will be discussed more fully below, the third major surface 214 may only be bonded locally to the second major surface 210, the third major surface 214 may only be lightly tacked to the second major surface 210, and/or the third major surface 214 may be mechanically attached to the second major surface 210. In this way, the surface texture of the adhesive region 206 is maintained to allow for air removal upon subsequent lamination. That is, when a pressure of at least 110 psi is applied to the laminate preform 300, air can be removed from the space between the adhesive region 206 and the first glass ply 202 due to the initial tacking or mechanical bonding.

In one or more embodiments of the laminate preform 300, such as the embodiment shown in FIG. 3A, the fourth major surface 216 is not directly or indirectly bonded to glass material. In this way, the fourth major surface 216 remains available for bonding to a glass material, such as second glass ply 204, to form the laminate 200. In one or more embodiments, the second major surface 210 has a first surface area, and the third major surface 214 has a second surface area. In one or more embodiments, the second surface area is at least 90% of the first surface area. Thus, in one or more embodiments, the adhesive region 206 covers more than 90% of a surface area of the second major surface 210, and an entirety of the fourth major surface 216 is accessible for bonding to another glass ply.

In one or more embodiments, the adhesive region 206 is attached to the first glass ply 202 by tacking the adhesive region 206 to the first glass ply 202. For example, the adhesive region 206 can be tacked to the first glass ply 202 by placing the adhesive region 206 against the first glass ply 202 and heating the first glass ply 202 from the first major surface 208 to indirectly heat the adhesive region 206. Such heating may be done at various locations on the first major surface 208 such that the adhesive layer 206 is tacked to the first glass ply 202 at discrete locations.

Alternatively or additionally, the first glass ply 202 may be preheated, and the third major surface 214 of the adhesive region 206 may be pressed against the second major surface 210 of first glass ply 202 while cooling the fourth major surface 216 of the adhesive region 206. In this way, the third major surface 214 of the adhesive region 206 becomes tacked to the first glass ply 202, while the fourth major surface 216 is prevented from deteriorating for later attaching to the second glass ply 204. That is, the surface roughness of the fourth major surface 216 is substantially retained.

Alternatively or additionally, one or both of the second major surface 210 of the first glass ply 202 and the third major surface 214 of the adhesive region 206 is chemically treated to activate the surface for temporarily bonding of the adhesive region 206 to the first glass ply 202. In one or more embodiments, the second major surface 210 and/or the third major surface 214 is chemically treated with alcohol (e.g., isopropyl alcohol) or acetone to activate the surface for temporary bonding.

According to any of the foregoing embodiments, the adhesive region 206 may be oversized relative to the first glass ply 202 when joined to the first glass ply 202 to form the preform 300. Thereafter, the adhesive region 206 can be trimmed to provide the final preform 300 shape.

With reference now to FIG. 4, the laminate preform 300 in one or more embodiments includes a release layer 302. In one or more embodiments, the release layer 302 includes a PET film or includes a film backer with a low-adhesion coating, such as a coating of silicone. In one or more embodiments, the adhesive region 206 is disposed between the release layer 302 and the first glass ply 202. In particular, the release layer 302 is attached to the adhesive region 206. The release layer 302 is configured to protect the adhesive region 206 from contamination or from accidentally sticking to another object. Further, the release layer 302 allows for stacking of multiple laminate preforms 300 for storage and shipping. That is, by providing the release layer 302 over the adhesive region 206, placing a second preform 300 over a first preform 300 will not lead to sticking of the preforms 300 to each other.

Further, in one or more embodiments, the preform 300 or a stack of preforms 300 can be stored in a sealed, foil-lined bag 303 to maintain a desired moisture level. In particular, ambient conditions may prematurely dry out or cure the adhesive region 206, and the foil-lined bag 303 may slow or stop such degradation of the adhesive region 206. Further, to address the issue of moisture, in one or more embodiments, the adhesive region 206 is selected to be a material with a low tendency for moisture absorption. Examples of such materials for the adhesive region 206 include EVA and TPU.

In one or more embodiments, the release layer 302 is configured to impart surface roughness or a surface texture to the adhesive region 206. For example, the film backer or coating may be formed to have a negative of the roughness or the texture to be imparted onto the fourth major surface 216 of the adhesive region 206. In such embodiments, the imparted surface roughness or texture provides a leak path for removal of air from between the adhesive region 206 and the second glass ply 204 during assembly of the laminate 200 (as shown in FIGS. 2 and 3B). Additionally, the surface roughness or texture may facilitate removal of the release layer 302 from the adhesive region 206.

In one or more embodiments of the laminate preform 300, the adhesive region 206 is attached to the second major surface 210 by bonding at a first bond strength, and the release layer 302 is attached to the adhesive region 206 by bonding at a second bond strength. In one or more embodiments, the second bond strength is lower than the first bond strength. According to embodiments described herein, the bond strength is described in terms of peel strength as measured according to ASTM D903. In one or more embodiments, the fourth major surface 216 becomes accessible for bonding to another glass ply (i.e., second glass ply 204) via removal of the polymer release layer 302 disposed on the fourth major surface 216. The second bond strength being lower than the first bond strength facilitates removal of the release layer 302 from the adhesive region 206 without removing the adhesive region 206 from the first glass ply 202.

In the embodiments depicted in FIGS. 2, 3A, and 3B, the laminate 200 included just three layers of the first glass ply 202, the second glass ply 204, and the adhesive region 206 including a single adhesive layer. However, in one or more other embodiments, the laminate 200 may include additional layers. In such embodiments, the laminate preform 300 may include those additional layers attached together.

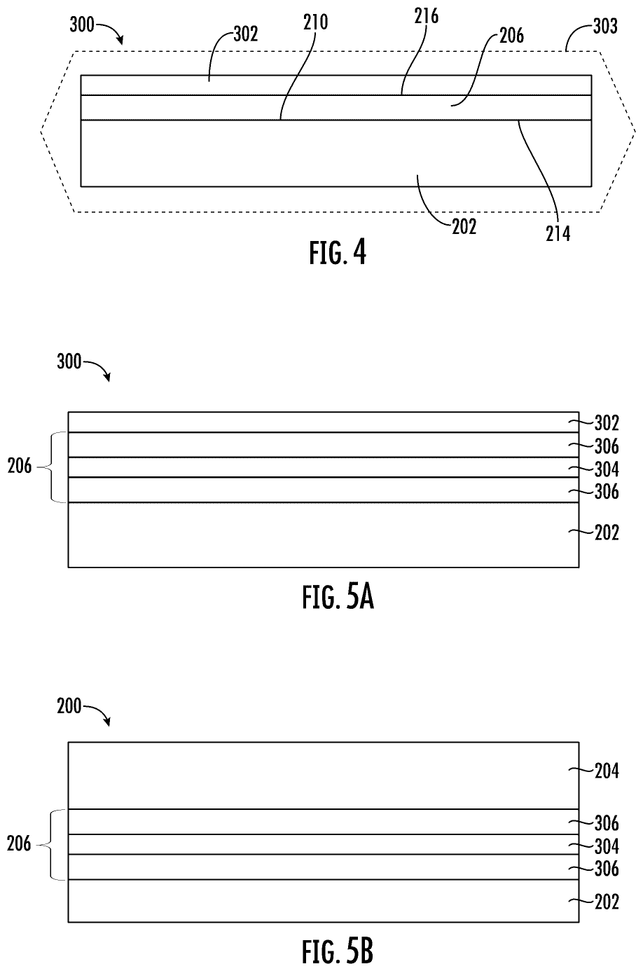

For example, as shown in FIG. 5A, the laminate preform 300 further includes a functional layer 304. In one or more such embodiments, the adhesive region 206 includes the functional layer 304 disposed between two adhesive layers 306. Thus, a first adhesive layer 306 is disposed between the functional layer 304 and the first glass ply 202. In one or more embodiments, the functional layer 304 comprises an infrared reflective layer. In one or more embodiments, the functional layer 304 comprises a display module, such as an organic light emitting diode (OLED) display, an e-ink display, or a dispersed liquid crystal display. In one or more embodiments, the functional layer 304 is a layer in which transmission of light in the visible spectrum through the first glass ply can be varied by application of an electric voltage, such as dispersed liquid crystals, suspended particle devices, or electrochromic films.

In one or more embodiments, the laminate preform 300 further includes a second adhesive layer 306 such that the functional layer 304 is disposed between the first adhesive layer 306 and the second adhesive layer 306. In one or more embodiments, the polymer release layer 302 is attached to the second adhesive layer 306 where such second adhesive layer 306 is provided.

As shown in FIG. 5B, to form the laminate 200, the polymer release layer 302 is removed, and the second adhesive layer 306 is attached to the second glass ply 204. In such embodiments, lamination of the stack of layers results in bonding between the first adhesive layer 306 and the first glass ply 202 and between the second adhesive layer 306 and the second glass ply 204.

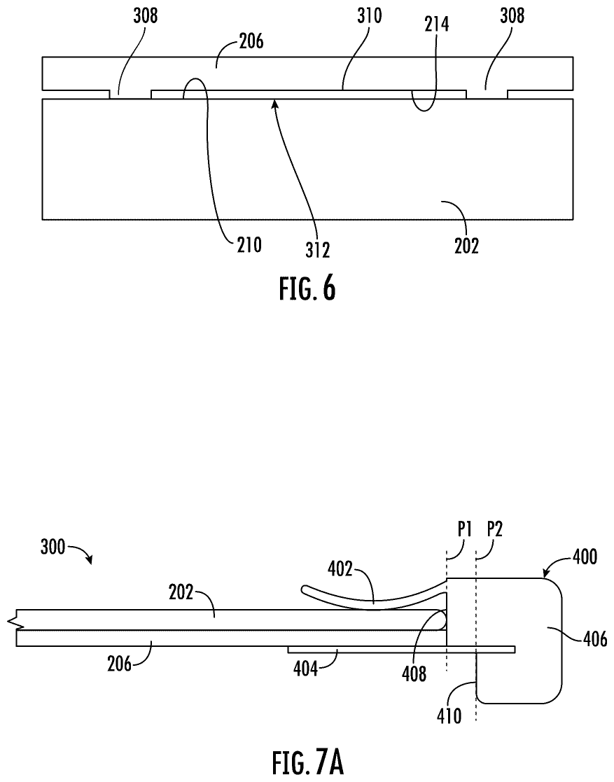

FIG. 6 depicts an embodiment of an adhesive region 206 partially attached to the first glass ply 202. In one or more embodiments, the third major surface 214 of the adhesive region 206 includes a plurality of first regions 308 within a second region 310. In one or more such embodiments, the first regions 308 are bonded to the second major surface 210 of the first glass ply 202, and the second region 310 is not bonded to the second major surface 210 of the first glass ply 202. In such embodiments, the second region 310 provides a fluid leak path 312 for air to be evacuated from between the adhesive layer 206 and the first glass ply 202 during lamination. In such embodiments, the first regions 308 may be bonded to the second major surface 210 of the first glass ply 202, such as by selective application of heat and pressure to the adhesive layer 206, but overall, the adhesive layer 206 is not fully bonded to the first glass ply 202 because of the fluid leak paths provided by the second region 310. In the embodiment shown in FIG. 6, the bonding between the first regions 308 and the first glass ply 202 and the fluid leak path 312 provided by the second region 310 are exaggerated to demonstrate the discussed features; however, in practice, the second region 310 may still be in contact or partial contact with the first glass ply 202 but just not bonded to the first glass ply 202. In particular, the second region 310 may be defined by the undisrupted surface roughness of the third major surface 214 of the adhesive region 206.

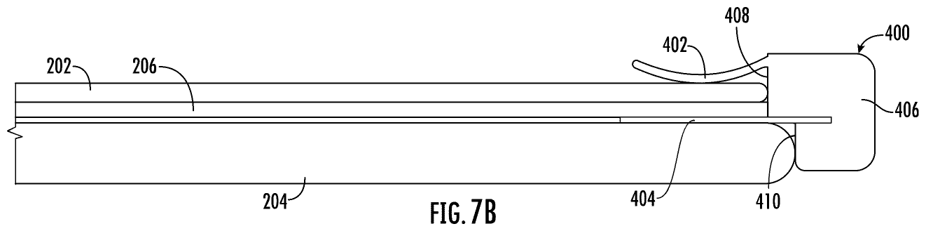

While the foregoing embodiments have described adhesive regions 206 that are tacked or partially bonded to the first glass ply 202, in one or more other embodiments, the adhesive region 206 may instead be mechanically attached to the first glass ply 202. For example, in one or more embodiments, the laminate preform 300 includes a clip 400 as shown in FIG. 7A. In one or more embodiments, the clip 400 includes a first arm 402 and a second arm 404 extending substantially perpendicularly from a body portion 406. The first glass ply 202 and the adhesive region 206 are clamped between the first arm 402 and the second arm 404. Further, in one or more embodiments, the body portion 406 of the clip 400 includes a first abutment wall 408 and a second abutment wall 410. As can be seen in FIG. 7A, the first glass ply 202 and the adhesive region 206 are abutted against the first abutment wall 408. The first abutment wall 408 defines a first plane P1, and the second abutment wall 410 defines a second plane P2. In one or more embodiments, the second plane P2 is offset from the first plane P1 in a direction away from the first glass ply 202 and adhesive region 206 (e.g., perpendicular to the minor surfaces 212 and 222 depicted in FIG. 2).

As shown in FIG. 7B, the clip 400 facilitates alignment of the second glass ply 204 with the first glass ply 202 and the adhesive region 206. In particular, the offset between the first abutment wall 408 and the second abutment wall 410 provides the desired offset between the first glass ply 202 and the second glass ply 204 for the final laminate 200.

While one clip 400 is depicted in FIGS. 7A and 7B to facilitate understanding of this concept, a laminate preform 300 may include a plurality of clips 400 positioned around the perimeter or a portion of the perimeter of the laminate preform 300. During lamination, the clips 400 are removed before the adhesive region 206 is fully bonded to the second glass ply 204. That is, to evacuate air between the second glass ply 204 and the adhesive region 206, pressure during lamination may be applied on an interior or central portion of the laminate preform 300 and moved outwardly to the periphery of the preform 300, pushing any entrapped air toward the perimeter of the preform 300 so that air bubbles are not present in the final laminate 200. Thus, in one or more embodiments, the clips are removed prior to removal of air and prior to application of heat to the stack of preform 300 and second glass ply 204.

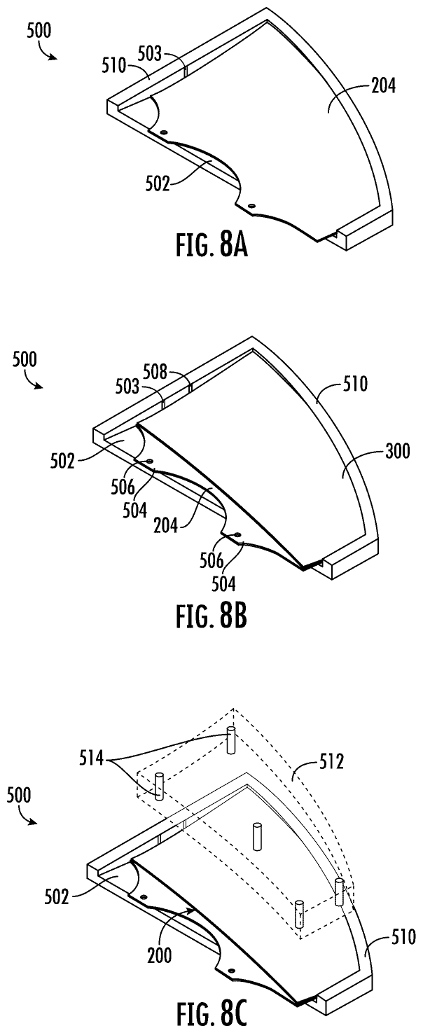

FIGS. 8A-8C depict an apparatus 500 and method for forming a laminate 200. Referring first to FIG. 8A, in one or more embodiments, the apparatus 500 includes a first mold 502 configured to receive the second glass ply 204. In one or more embodiments, the second glass ply 204 has previously been processed to include a permanent curvature through a high-temperature process, such as gravity sagging in a furnace or through a hot-pressing process. In one or more embodiments, the second glass ply 204 may be positioned and secured in place using one or more first alignment tabs 503.

After positioning the second glass ply 204 in the first mold 502, the laminate preform 300 is positioned over the second glass ply 204. As can be seen in FIG. 8B, the second glass ply 204 and the glass preform 300 may not have the same shape. For example, the second glass ply 204 may include mounting structures, such as tabs 504 including apertures 506, configured to assemble the glazing 130 with the vehicle.

Positioning the laminate preform 300 over the second glass ply 204 may be facilitated by one or more second alignment tabs 508. As with the abutment walls 408, 410 of the clip 400, the alignment tabs 503, 508 allow for easier and more accurate positioning of the laminate preform 300 relative to the second glass ply 204.

In one or more embodiments, the alignment tabs 503, 508 are movable. For example, the alignment tabs 503, 508 may flip or pivot over a sidewall 510 of the first mold 502, or the alignment tabs 503, 508 may be attached to the sidewall 510 of the first mold 502. In one or more such embodiments, the first alignment tabs 503 are positioned on the sidewall 510 of the first mold 502 so that the second glass ply 204 can accurately be inserted into the first mold 502. After the second glass ply 204 is positioned within the first mold 502, the second alignment tabs 508 are positioned against the sidewall 510 to retain the second glass ply 204 and to provide accurate positioning of the laminate preform 300.

As shown in FIG. 8C, a second mold 512 is configured to cold-form the laminate preform 300 against the curved second glass ply 204. In one or more embodiments, the second mold 512 includes heating elements 514 configured to tack the adhesive layer 206 of the laminate preform 300 in place against the curved second glass ply 204. Thereafter, the second mold 512 is removed, and the alignment tabs 508 are swing or flipped over the sidewall 510 so that the laminate 200 can be removed from the first mold 502.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A laminate preform, comprising:
a first glass ply having a first major surface and a second major surface, the second major surface being opposite to the first major surface, a thickness of the first glass ply being defined between the first major surface and the second major surface, the thickness being 2 mm or less; and
an adhesive region having a third major surface and a fourth major surface, the third major surface being disposed on the second major surface of the first glass ply;
wherein the third major surface of the adhesive region comprises at least a portion of an area of the third major surface not bonded to the second major surface so that air can flow between the third major surface and the second major surface.

2. The laminate preform of claim 1, wherein the fourth major surface is not directly or indirectly bonded to a glass material.

3. The laminate preform of claim 1, wherein the adhesive region comprises a polyvinyl butyral, an acoustic polyvinyl butyral, an ethylene-vinyl acetate, a thermoplastic polyurethane, an ionomer, a polyester, or a polyethylene terephthalate.

4. The laminate preform of claim 1, wherein the adhesive region comprises a functional additive, wherein the functional additive comprises at least one of a solar-absorbing pigment, a tinting colorant, UV absorbing compounds, light scattering particles, or adhesion promoters.

5. The laminate preform of claim 1, wherein the adhesive region further comprises a functional layer, wherein the functional layer comprises an infrared reflective layer or a display module.

6. The laminate preform of claim 5, wherein the adhesive region comprises a first adhesive layer and a second adhesive layer, the functional layer being disposed between the first adhesive layer and the second adhesive layer.

7. The laminate preform of claim 1, further comprising a release layer, wherein the adhesive region is disposed between the release layer and the first glass ply, wherein the fourth major surface is accessible for bonding to a second glass ply via removal of the release layer disposed on the fourth major surface, wherein the release layer is attached to the adhesive region.

8. The laminate preform of claim 7, wherein the release layer is configured to impart surface roughness or texture to the adhesive region.

9. The laminate preform of claim 8, wherein the adhesive region is attached to the second major surface by bonding at a first bond strength, wherein the release layer is attached to the adhesive region by bonding at a second bond strength, the second bond strength being lower than the first bond strength.

10. The laminate preform of claim 1, wherein the third major surface of the adhesive region comprises a plurality of first regions within a second region, the plurality of first regions being bonded to the second major surface of the first glass ply and the second region not being bonded to the second major surface of the first glass ply.

11. The laminate preform of claim 1, wherein the second major surface comprises a first surface area and the third major surface comprises a second surface area, the second surface area being at least 90% of the first surface area.

12. The laminate of claim 11, wherein an entirety of the fourth major surface is accessible for bonding to a second glass ply.

13. The laminate preform of claim 1, further comprising a clip, the clip comprising a first arm and a second arm extending from a body portion, wherein the first glass ply and the adhesive region are clamped between the first arm and the second arm.

14. The laminate preform of claim 13, wherein the body portion of the clip comprises a first abutment wall and a second abutment wall, the first glass ply and the adhesive region being abutted against the first abutment wall, wherein the first abutment wall defines a first plane and the second abutment wall defines a second plane, the second plane being offset from the first plane in a direction away from the first glass ply and adhesive region.

15. A method of preparing a laminate preform, comprising:
attaching an adhesive region to a first glass ply, the first glass ply comprising a first major surface and a second major surface, the second major surface being opposite to the first major surface, the adhesive region comprising a third major surface and a fourth major surface in which the third major surface is disposed on the second major surface;
wherein the third major surface is attached to the second major surface and wherein the third major surface comprises at least a portion of area not bonded to the second major surface so that air can flow between the third major surface and the second major surface.

16. The method of claim 15, wherein attaching further comprises heating the first glass ply and pressing the adhesive region against the heated first glass ply such that heat from the first glass ply softens the adhesive region to bond to the first glass ply.

17. The method of claim 16, wherein heating further comprises heating the first glass ply in a plurality of local regions such that, after pressing the adhesive region against the heated first glass ply, the third major surface of the adhesive region comprises a plurality of first regions bonded to the first glass ply within a second region that is not bonded to the first glass ply.

18. The method of claim 17, further comprising attaching a release layer to the fourth major surface of the adhesive region, wherein the release layer comprises a surface roughness or texture and the method further comprises imparting the surface roughness or texture of the release layer onto the fourth major surface of the adhesive region.

19. The method of claim 17, further comprising:
cold-forming the laminate preform against a second glass ply comprising a curvature, the second glass ply having a fifth major surface and a sixth major surface, the sixth major surface being opposite to the fifth major surface, the fifth major surface and the sixth major surface defining a second thickness therebetween, the second thickness being greater than a thickness of the first glass ply;
attaching the fourth major surface of the adhesive region to the fifth major surface of the second glass ply;
wherein the first glass ply conforms to the curvature of the second glass ply.
